(19) United States
(12) Patent Application Publication
(10) Pub. No.: US 2018/0364150 A1
(43) Pub. Date: Dec. 20, 2018

(54) OPTICAL MONITORING OF TARGET CHARACTERISTICS

(71) Applicant: Cypress Semiconductor Corporation, San Jose, CA (US)

(72) Inventor: Darrin T. Vallis, Austin, TX (US)

(73) Assignee: Cypress Semiconductor Corporation, San Jose, CA (US)

(21) Appl. No.: 15/713,055

(22) Filed: Sep. 22, 2017

Related U.S. Application Data
(60) Provisional application No. 62/519,651, filed on Jun. 14, 2017.

(51) Int. Cl. G01N 17/04; G01N 21/55; G01N 17/00; G01N 21/31; G01N 21/95; G01N 21/63

(52) U.S. Cl. CPC G01N 17/04; G01N 21/55; G01N 17/006; G01N 2021/558; G01N 21/95; G01N 21/63; G01N 21/31

(57) ABSTRACT

An optical monitor includes a target disposed within the optical monitor and exposed to ambient air, wherein exposure to the ambient air produces a change in an optical property of the target. The optical monitor may also include a light emitter to illuminate the target and an optical detector to generate a signal based on light reflected from or transmitted through the target. A processing device may activate the light emitter and receive the signal from the optical detector.

### CROSS-REFERENCE TO RELATED APPLICATIONS

This application claims the benefit of U.S. Provisional Application No. 62/519,651 filed on Jun. 14, 2017, the entire contents of which are hereby incorporated by reference.

### BACKGROUND

Monitoring adverse effects on equipment deployed in manufacturing, medical and healthcare environments, office spaces, homes, automobiles, or other spaces may improve the operation, or lifespan of that equipment. However, monitoring certain effects on various parts may provide challenging for some systems.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a schematic diagram of an embodiment of an optical monitor, which can be used in accordance with some embodiments.

FIG. 2 is a schematic diagram of a side view of an embodiment of an optical monitor, which can be used in accordance with some embodiments.

FIG. 3 is a schematic diagram of a side view of an embodiment of an optical monitor, which can be used in accordance with some embodiments.

FIG. 4 is a schematic diagram of a top view of an embodiment of an optical monitor, which can be used in accordance with some embodiments.

FIG. 5 is a schematic diagram of a top view of an embodiment of an optical monitor, which can be used in accordance with some embodiments.

FIG. 6 is a schematic diagram of an embodiment of an optical monitoring system, which can be used in accordance with some embodiments.

FIG. 7 is a flow diagram depicting a method of determining a characteristic of a target, in accordance with some embodiments.

### DETAILED DESCRIPTION

Corrosion can be a significant cost for individual systems, companies, and the economy as a whole. For example, automobiles, networking, and server equipment are regularly exposed to harsh environments during service life. Increasing air pollution combined with data center low cost “fresh air” cooling costs equipment manufacturers millions in returns. For automotive manufacturers, water damage and in-service corrosion create significant expense. Furthermore, other industries, such as utilities, transportation, infrastructure and manufacturing would also benefit from a low cost corrosion monitoring solution.

In some embodiments, optical monitors disclosed herein detect corrosion optically in a semiconductor chip scale, self-contained package. In some embodiments, a target corrosion sample is situated in a device cavity. The target corrosion sample may be metal, or another material coated in metal, to act as a representative part of a system being monitored. Thus, the optical monitor can use corrosion on the target to determine if there has been corrosion in the system. In some embodiments, the target corrosion sample may be isolated from external ambient light. For example, one or more baffles allow external atmosphere to enter the cavity. Over time, as the target corrosion sample is exposed to air, the target may corrode.

To test corrosion, the target may be illuminated by optical emitters. In some embodiments, the optical emitters provide light at wavelengths or spectrums chosen depending on the target type and the corrosive atmosphere. For example, the optical emitters may provide light in the visible spectrum, infra-red spectrum, ultraviolet spectrum, or any other wavelengths of light. Accordingly, an optical monitor may target specific types of corrosion for specific metals in specific environments. One or more optical monitors may receive light reflected from the target. A change in the reflectance of the target may be used by a processing device to determine that corrosion has occurred. In some embodiments, the data from the optical monitors, or any determination of corrosion, may be transmitted from the optical monitor to a host system.

In some embodiments, the optical monitor may continuously monitor a target for changes caused by the environment. For example, a processing device of the optical monitor may activate light emitters periodically to illuminate the target. The optical detectors may then generate a signal based on light reflected from or passed through the target. The processing device may then log the data, determine if there is corrosion based on the generated signal, or provide the data to a host system in order for the host system to determine the state of corrosion of the target. By repeating the process periodically, the processing device may create continuous monitoring of the state of corrosion.

The optical monitor may have inputs of environmental factors that may affect the target factor. For example, the optical monitor may have inputs of airborne particulate contaminants, corrosive gasses, temperature, humidity, biological agents, or other environmental factor that may have an effect on a target.

Based on the change in optical properties of the target, the optical monitor may output a raw set of data indicating the signals generated by the optical detectors. In some embodiments, the optical monitor may process the data received from optical detectors to determine a level of corrosion or other environmental effect. Furthermore, in some embodiments, the optical monitor may determine whether the change in an optical property has satisfied a threshold and provide an indication that the threshold has been satisfied.

In some embodiments, an optical monitor may be implemented as a chip-scale semiconductor device. The semiconductors device may be provided in newly manufactured products, or deployed as a replaceable module. For example, a semiconductor may be installed on new servers, airflow controllers, automobiles, or the like to determine that state of corrosion within those systems. Corrosion monitoring by the optical monitor may be applied to monitoring automotive water corrosion, monitoring server or networking atmospheric corrosion, or monitoring corrosion of manufacturing facilities.

While described with reference to corrosion, the optical monitors described herein may also be used to monitor other environmental effects of different targets. For example, by changing the target, the optical monitor may detect other environment effects. In some embodiments, the optical monitor may also use light emitters with a different spectrum of light or optical detectors that detect a different wavelength of light. For example, using different samples an optical monitor may also detect organic contamination such as fungi, mold, mildew, algae, and bacteria. Detection of organic contamination may be applied across a wide range of industries such as medical, restaurant, HVAC, and food processing.

Accordingly, embodiments of the optical monitors described herein provide autonomous monitoring of environmental effects on a target. Furthermore, the optical monitors may be miniaturized to provide a monitor on a single semiconductor chip. The optical monitor may also be low cost, and versatile to detect a number of environmental effects on one or more targets. Corrosion of components of computer systems may reduce the integrity of contacts with components of the system or enclosures of components of the computer system. With increasing corrosion, the likelihood of failure of a component of a computer system or eventually the entire system increases.

In some embodiments, other monitoring processes other than optical may be used within a monitor as described herein. For example, a monitor may use a target exposed to ambient air through baffles, but use electrical resistance across the target as an indication of an environmental effect instead of optical measurements. In some embodiments, such other monitoring processes may include electrical resistance, inductive resistance, light polarization, hydrogen penetration, electrochemical impedance spectroscopy, electrochemical noise, electrochemical frequency modulation, zero resistance ammetry, gamma radiography, electrical field signature method, galvanic current, acoustic emission, corrosion potential, hydrogen flux monitoring, or chemical analysis.

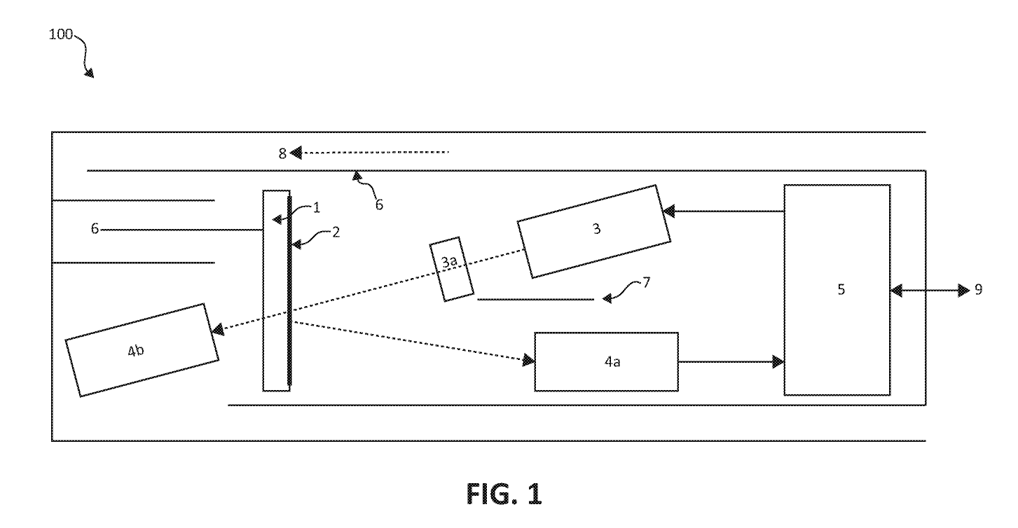

FIG. 1 depicts an embodiment of an optical monitor 100. In some embodiments, the optical monitor 100 includes a target 1, an optical emitter 3, one or more optical detectors 4A, 4B, a controller 5, one or more ambient air baffles 6, an emitter baffle 7, and a communications interface 9. The optical monitor 100 may allow ambient air 8 to enter a chamber housing the target 1.

In some embodiments, the optical monitor 100 may be affixed to, or disposed close to, a monitored system. For example, to monitor corrosion in a computer system, the optical monitor 100 may be affixed to the computer system. Accordingly, the target 1 may receive similar exposure to ambient air as similar materials within the computer system. Thus, the target 1 may be expected to experience a similar level of corrosion to components of the computer system. The optical monitor 100 may therefore monitor the expected corrosion of components of the computer system based on corrosion to the target 1. In some embodiments where the optical monitor 100 is monitoring other systems, the optical monitor 100 may be similarly placed in a position to experience similar exposure to an environment of a monitored system. Based on the positioning and processes performed by the optical monitor 100, the optical monitor 100 may monitor a system at the location of the system, without removing a target 1 for testing, or using other systems separate from the monitored system.

In some embodiments, the target 1 may be a material which will change reflectance based on the variable of interest. For example, to monitor corrosion, target 1 may be a metal such as copper, silver or steel. Alternately, target may be a non-metallic material coated with a metal film. To monitor bacterial growth, target 1 will be coated with a substance favorable to growth of specific bacteria. For bacterial applications, target may also be hollow and transparent, such that target 1 is a vessel containing a target substance. In some embodiments, the target 1 may be a microscopically perforated metal that provides an indication of reflectance and transmission changes. The target 1 may also be an optically transparent thin metal coating such as indium tin oxide, silver nanowires, copper or the like to allow detection of reflectance and transmission changes. In order to detect biological growth, the target 1 may be a solid or transparent target with a coating to promote growth of a biological agent. For example, a coated solid target may be used to detect changes in reflectance and a coated transparent target may be used to detect changes to reflectance and transmission changes.

Over time, based on the target 1 and the ambient air 8, the target 1 may develop a change in optical properties 2 that may be detected by the optical monitor 100. The change in optical properties 2 may be caused by corrosion, bacterial growth, fungal growth, or other environmental changes. In some embodiments, the change in optical properties 2 may increase or decrease either reflectance or transmission of the emitted light.

In some embodiments, light emitter 3 provides illumination of specific wavelength and spectral content. Different targets 1 may respond differently to various emitter frequencies. Depending on properties of the target 1 and the monitored change to the target 1, an emitter with broad or narrow bandwidth may be most efficient. Therefore, the light emitter 3 may be selected to maximize change in light reflected from or transmitted through the target 1. In some embodiments a single emitter may be used to provide a single spectrum of light to the target 1. In some embodiments, multiple emitters 3 may be aimed at the target sample. For example, multiple emitters 3 may be activated sequentially to time multiplex the frequencies of light incident on the target 1. The additional emitters 3 may increase the data collected by optical detectors 4A, 4B. Accordingly, in some embodiments optical monitor 100 may include single or multiple emitters 3 that each emit single or multiple emitters. For multiple emitters 3 that emit light at different frequencies, those frequencies may be time division multiplexed on target 1 or frequency division multiplexed on the target 1.

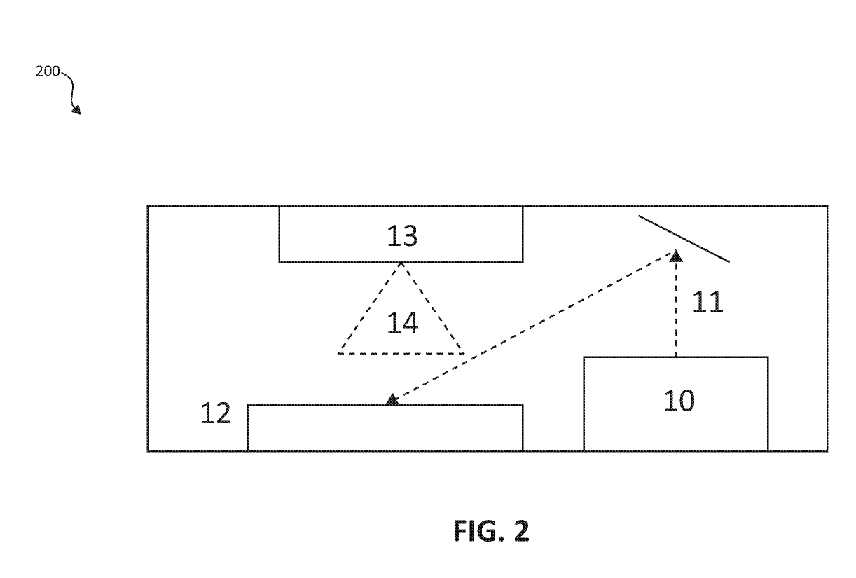

In some embodiments, the light emitter 3 may be a broad band emitter. For example, the light emitter 3 may be a traceable halogen light source, or the like. In such embodiments, the light emitter 3 may have a narrow band filter 3A that tunes the light to specific frequencies of interest. Additional embodiments of light emitter 3 are discussed with reference to FIGS. 2-5.

In some embodiments, optical detectors 4a, 4b measure changes in optical properties 2 of the target 1. As shown in FIG. 1, optical detector 4a measures light reflected from the target 1, which changes in the presence of corrosion, mold, mildew, bacteria, or the like. When using a transparent sample, optical detector 4b measures the change in target transmissivity. Optical detectors 4A and 4B are chosen such that their spectral sensitivity is greatest in the light frequency of interest for a given target 1 and change in optical properties 2. Although shown in FIG. 1 with two light detectors 4a, 4b, optical monitor 100 may have a single light detector (e.g., one of light detector 4a or 4b). In some embodiments optical monitor 100 may have fewer or additional light detectors than shown in FIG. 1. For example, there may be a single detector to detect a single frequency, a single detector to detect multiple frequencies, multiple detectors detecting a single frequency, multiple detectors detecting multiple frequencies, or any other combination of light detectors. Furthermore, single or multiple light detectors may be disposed to detect reflected light, transmitted light, or a combination of reflected and transmitted light. Additional embodiments of light detectors 4a, 4b are discussed with reference to FIGS. 2-5.

In some embodiments, a controller 5 may execute programming operations to implement required functionality of the optical monitor 100. For example, controller 5 may activate optical emitters 3 in sequence and measure output from optical detectors 4a, 4b. The controller 5 may then store the data or forward measurement data to a host system via a communications interface 9. In some embodiments, the controller 5 may also analyze data on the optical monitor. For example, the controller 5 may determine if an output from an optical detector 4a, 4b changed enough to satisfy a threshold. For example, the controller may trigger an alert if one or more outputs from one or more optical detectors 4a, 4b fall above or below a threshold. In some embodiments, the controller 5 may also measure and store additional data. For example, the controller 5 may also measure and store temperature and humidity to determine the relationship between the change in optical properties 2 and other environmental factors such as temperature and humidity.

In some embodiments, the controller 5 may be a processing device. For example, the processing device may include one or more processors such as a microprocessor, central processing unit, or the like. In some embodiments the processing device 9 may be an application specific integrated circuit (ASIC), a field programmable gate array (FPGA), a digital signal processor (DSP), complex programmable logic device (CPLD), or the like. Furthermore, the processing device may include one or more memory devices such as a main memory, random access memory, or other computer readable storage mediums.

In some embodiments, light baffles 6 may prevent ambient light from interfering with the optical detectors 4a, 4b. Thus, the light baffles 6 may allow ambient air 8 to enter the system, while preventing light from entering the system. This reduces noise and interference with the light detected by light detectors 4a, 4b. In some embodiments, ambient air 8 is allowed to flow naturally through light baffles 6. In some embodiments, a fan or other source may be used to increase the airflow through light baffles 6 and interacting with target 1. In some embodiments, there may be fewer or additional baffles than are shown in FIG. 1.

In some embodiments, optical monitor 200 may also include an emitter baffle 7. The emitter baffle 7 may reduce the optical cross talk between the optical emitter 3 and the optical detectors 4a, 4b. For example, the emitter baffle 7 may prevent light from reaching from optical emitter 3 to optical detectors 4a, 4b that isn't reflected from or transmitted through the target 1. In some embodiments, there may be fewer or additional emitter baffles 7 than are shown in FIG. 1.

FIG. 2 depicts an embodiment of an optical monitor 200. The optical monitor 200 may include a target 12 and an optical detector 13 similar to those described with reference to optical monitor 100 of FIG. 1. In FIG. 2, the optical monitor 200 may use a vertical cavity surface emitting laser 10 (VCSEL or “Vixel”) as a light source. A vixel 10 may be a smaller source compared to an incandescent or other light source. A vixel 10 may also generate less heat and consume less energy than other light sources. To fit in a semiconductor package, the vixel 10 may be directed upward from a substrate and emitted light may reflect off a reflector 11 to illuminate the target 12. The light reflected from reflector 11 may be targeted to impact the target 12 within a field of view 14 of an optical detector 13.

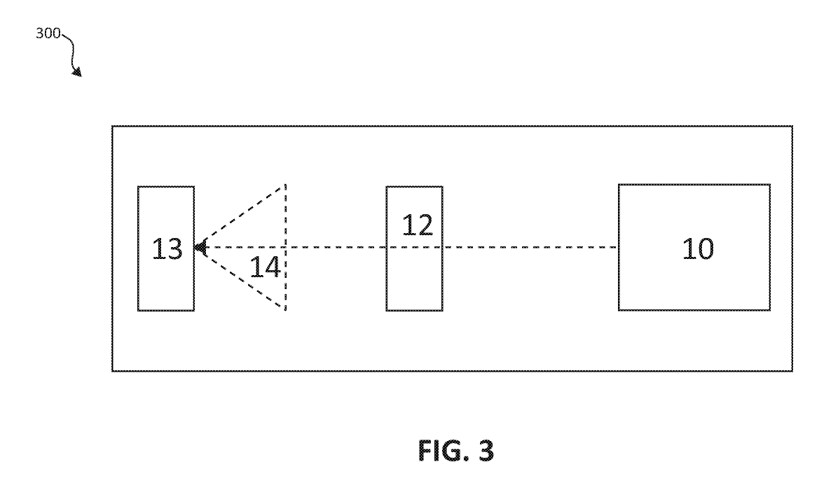

In some embodiments, other configurations of optical monitor 200 may be used to direct light from a vixel 10 to a target 1. For example, the target 1 may be positioned directly in line with the emitted light of vixel 10 an optical detector 13 may be have a field of view 14 that sees the light reflected from the target 12. Furthermore, as shown in FIG. 3, in the case of a transparent target 12, the optical detector 13 may be positioned on the other side of the target 12, or the target 12 may be positioned between the vixel 10 and the optical detector 13. While FIGS. 2 and 3 are described as using a vixel 10, in some embodiments, other light emitting sources may be used and reflected toward target 12.

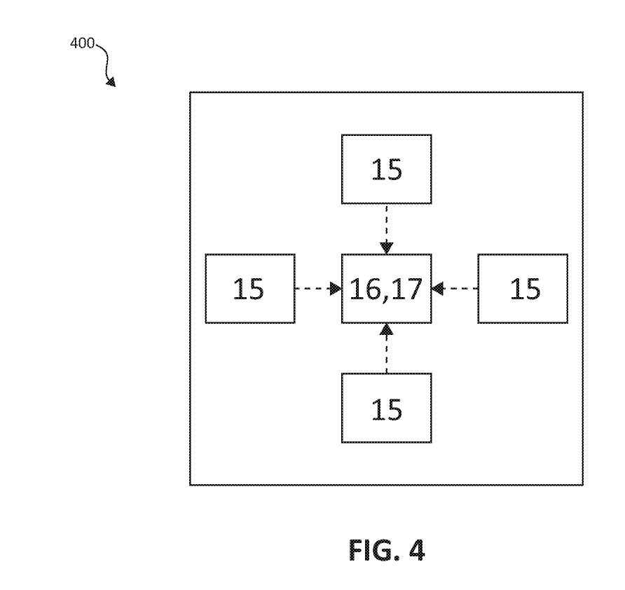

FIG. 4 depicts a top view of embodiment of an optical monitor 400 having multiple light emitters 15. As shown in FIG. 4, optical monitor 400 includes multiple emitters 15, a target 16, and an optical detector 17. For example, the light emitters 15 may be similar to those described with reference to FIG. 2. Thus, the light emitters 15 may include a vixel and a reflector to direct the light at target 16. The light emitters 15 may be spaced around the target 16 as shown in FIG. 4. In some embodiments, the light emitters 15 may emit light at different frequencies to increase the data generated by probing the target 16. In some embodiments, as shown in FIG. 4, the optical detector 17 may be positioned over the target 12 as discussed with reference to FIG. 2. In some embodiments, a controller (not pictured) may activate the light emitters 15 in sequence and receive signals from optical detector 17 in sequence to measure particular frequencies from light emitters 15. In some embodiments, there may be more than one light detector 17 such that multiple light detectors 17 may measure different frequencies. In some embodiments, there may be fewer or additional light emitters 15, targets 16, or optical emitters 17. Furthermore, the arrangement of the components of optical monitor 400 may be different than shown in FIG. 4.

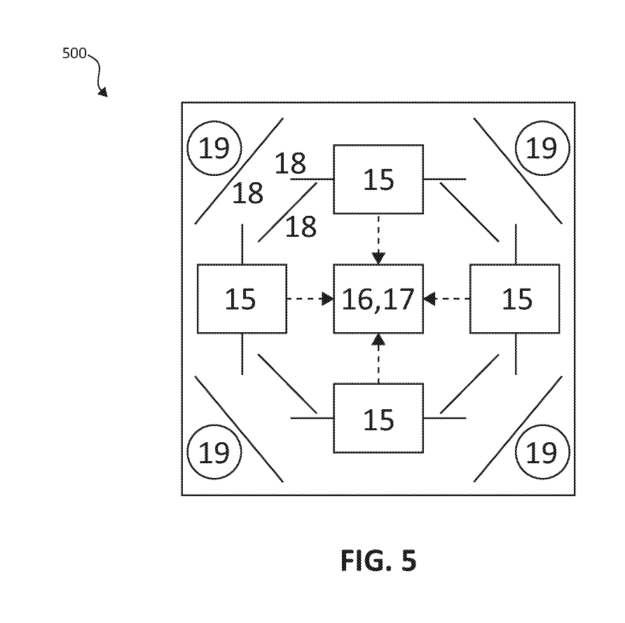

FIG. 5 depicts a top view of embodiment of an optical monitor 500 having a plurality of baffles 18 and apertures 19. The apertures 19 may allow the flow of ambient air into a chamber housing the light emitters 15, target 16, and optical detectors 17. Baffles 18 may act to prevent ambient light entering through apertures 19 with ambient air from interacting with target 16. In addition, one or more baffles 18 may also act to prevent light contamination from a light emitter 15 to an optical detector 17 that was not incident on the target 16. In some embodiments, the light emitters 15 may emit light at different frequencies to increase the data generated by probing the target 16. In some embodiments, as shown in FIG. 5, the optical detector 17 may be positioned over the target 12 as discussed with reference to FIG. 2. In some embodiments, a controller (not pictured) may activate the light emitters 15 in sequence and receive signals from optical detector 17 in sequence to measure particular frequencies from light emitters 15. In some embodiments, there may be more than one light detector 17 such that multiple light detectors 17 may measure different frequencies. In some embodiments, there may be fewer or additional light emitters 15, targets 16, or optical emitters 17. Furthermore, the arrangement of the components of optical monitor 500 may be different than shown in FIG. 5.

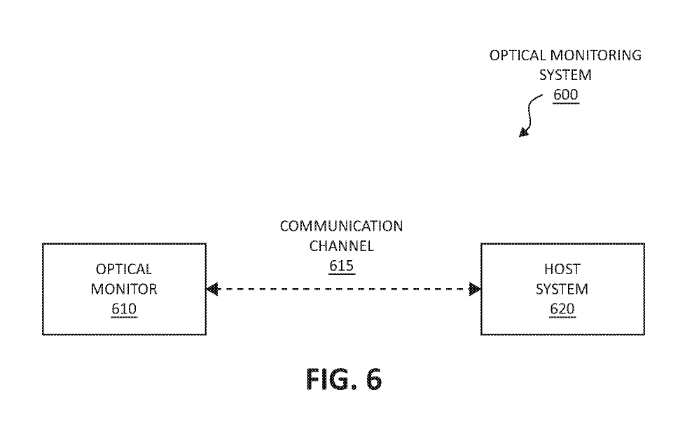

FIG. 6 is a schematic diagram of an embodiment of an optical monitoring system 600. Optical monitoring system 600 may include an optical monitor 610, a communication channel 615 and a host system 620. The optical monitor 610 may be an optical monitor as described with reference to one of FIGS. 1-5. For example, optical monitor 610 may include a target, a light emitter, an optical detector, baffles, or other features as described above. In some embodiments, the optical monitor 610 monitors corrosion of servers in a data center. The optical monitor 610 may be affixed to or disposed near one or the servers in the data center. The optical monitor 610 may monitor corrosion of the target as a proxy for corrosion of components of the servers in the data center. For example, components of the servers may include enclosures of computing devices, contacts between computing devices, metallic traces on semiconductors, or other components and structures that may be affected by corrosion. For instance, contacts, traces, or enclosures may fail or reduce their efficiency due to corrosion. In some embodiments, optical monitor 610 may monitor other systems and may be placed in a location that provides an indication of changes to components of such systems by monitoring the target as a proxy.

Communication channel 615 may be a wired or wireless communication channel between the optical monitor 610 and a host system 620. For example, the communication channel may include a local area network (LAN), an intranet, an extranet, or the Internet. The optical monitor 610 may have a network interface card (NIC) or other communication component to transmit or receive message from the host system 620. The hose system 620 may be a computer system such as a server, a personal computer, a tablet PC, a set-top box (STB), a cellular telephone, or another computing resource capable of transmitting or receiving messages from optical monitor 610.

In some embodiments, the optical monitor 610 autonomously monitors a target to measure changes in the optical properties of the target. The optical monitor 610 may then transmit the measured data to the host system 620 over communication channel 615. The optical monitor 610 may transmit data as it is generated or may periodically transmit logged data. In some embodiments, the optical monitor 610 analyzes the data to characterize the changes in the optical data. For example, the optical monitor 610 may analyze the data to determine a level of corrosion. The optical monitor 610 may provide an indication of analyzed data to the host system 620. Furthermore, in some embodiments, the optical monitor 610 may determine if the raw data generated by an optical detector or analyzed data satisfies one or more thresholds. For example, the optical monitor 610 may determine if one or more elements of the raw data drop above or below a threshold. For instance, optical monitor 610 may determine that the intensity of light dropped below a threshold value. In some embodiments, the optical monitor 610 may perform additional analysis on received data. For example, the optical monitor 610 may determine if a change in an optical property at one or more frequencies has changed more than a threshold amount during a predetermined amount of time or number of samples. The optical monitor 610 may transmit an indication of any thresholds that are met to the host system 620.

In some embodiments, the host system 620 receives data from the optical monitor 610 and analyzes the data. For example, the host system 620 may receive an indication of measurements from optical detectors. The host system 620 may then determine a level of corrosion, bacteria or fungal growth, or the like based on the received data. In some embodiments, the host system 610 may receive additional information from the optical monitor 610. Furthermore, in some embodiments, the host system 620 may receive data from multiple optical monitors 610 and may determine operation of a system based on feedback from multiple optical monitors 610.

In some embodiments, the host system 620 may transmit additional commands to the optical monitor 610. For example, the host system 620 may configure the optical monitor to probe the target with particular frequencies of light from particular light emitters, set a periodic schedule for probing the target, request log data, request a one-time set of measurements of a target, or the like. The optical monitor may receive these commands and update its configuration or perform the requested commands.

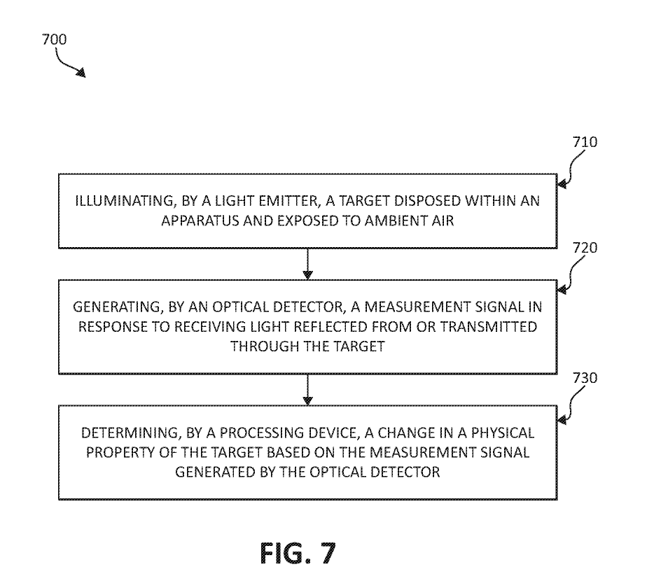

FIG. 7 is a flow diagram depicting a method 700 of determining a characteristic of a target, in accordance with some embodiments. The method 700 may be initiated by a controller or processing device that is part of one of the optical monitors described with reference to FIGS. 1-6. Beginning in block 710, an optical monitor illuminates a target disposed within an apparatus and exposed to ambient air. The optical monitor may illuminate the target with one or more light emitters as discussed above.

In block 720, an optical detector of the optical monitor may generate a measurement signal in response to receiving light reflected from or transmitted through the target. In some embodiments, there may be separate optical detectors to receive transmitted and reflected light. Multiple optical detectors may generate different measurements based on different frequencies of light received. In some embodiments, an optical monitor may repeat the processes of blocks 710 and 720 to probe a target with multiple frequencies of light to generate additional data from one or more optical detectors.

In block 730, the processing device may determine a change in a physical property of a target a based on the measurement signal generated by the optical detector. For example, the processing device may determine if there is additional corrosion, bacteria or fungal growth, contamination, or the like. Furthermore, in some embodiments, the processing device may determine that a change in an optical property satisfies one or more thresholds.

In some embodiments, a host system as described with reference to FIG. 6 may control the process of method 700. For example, the host system may transmit a command activating a light emitter and receive raw data generated by an optical detector. The host system may then analyze the data to determine one or more characteristics of the target.

Certain embodiments may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and or alternating manner. The terms “first,” “second,” “third,” “fourth,” etc. as used herein are meant as labels to distinguish among different elements and may not necessarily have an ordinal meaning according to their numerical designation. As used herein, the term “coupled” may mean connected directly or indirectly through one or more intervening components. Any of the signals provided over various buses described herein may be time multiplexed with other signals and provided over one or more common on-die buses. Additionally, the interconnection and interfaces between circuit components or blocks may be shown as buses or as single signal lines. Each of the buses may alternatively be one or more single signal lines and each of the single signal lines may alternatively be buses.

The above description sets forth numerous specific details such as examples of specific systems, components, methods, and so forth, in order to provide an understanding of several embodiments of the present invention. It may be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Embodiments of the claimed subject matter include, but are not limited to, various operations described herein. These operations may be performed by hardware components, software, firmware, or a combination thereof.

The above description sets forth numerous specific details such as examples of specific systems, components, methods, and so forth, in order to provide an understanding of several embodiments of the claimed subject matter. It may be apparent to one skilled in the art, however, that at least some embodiments of the may be practiced without these specific details. In other instances, well-known components or methods are not described in detail or are presented in simple block diagram format. Thus, the specific details set forth are merely exemplary. Particular implementations may vary from these exemplary details and still be contemplated to be within the scope of the claimed subject matter.

1. An optical monitor comprising:
a target representative of a component of a monitored system, the target disposed within the optical monitor and exposed to ambient air, wherein exposure to the ambient air produces a change in an optical property of the target;
a light emitter configured to illuminate the target;
an optical detector configured to generate a signal based on light reflected from or transmitted through the target; and
a processing device configured to activate the light emitter and receive the signal from the optical detector;
wherein the processing device is a semiconductor chip disposed within the optical monitor.

2. The optical monitor of claim 1, further comprising a baffle configured to provide the ambient air to the target and block ambient light from reaching the target or the optical detector.

3. The optical monitor of claim 1, further comprising a baffle configured to reduce light from reaching the optical detector from the light emitter other than light interacting with the target.

4. The optical monitor of claim 1, wherein the processing device is further configured to analyze the signal from the optical detector and determine a change in a physical property of the target.

5. The optical monitor of claim 1, wherein the light emitter comprises a vertical cavity surface emitting laser.

6. The optical monitor of claim 1, further comprising a second light emitter, wherein the second light emitter provides light at a different frequency than a frequency of light provided by the light emitter.

7. The optical monitor of claim 6, further comprising a second optical detector, wherein the second optical detector is configured to receive light at the different frequency.

8. The optical monitor of claim 1, wherein the processing device is further configured to:
determine that the signal received from the optical detector satisfies a threshold; and
in response to determining that the signal satisfies the threshold, generating an indication that the threshold is satisfied.

9. The optical monitor of claim 1, further comprising a communication interface, wherein processing device is configured to communicate with a host system through the communication interface.

10. The optical monitor of claim 1, wherein the target is a copper, silver, steel, or a material coated with a metal film, and the optical property is changed based on corrosion of the target.

11. The optical monitor of claim 1, wherein the target is a transparent target coated with a substance to promote bacteria growth or mold, and the optical property is changed based on the bacteria growth or mold on the target.

12. A method comprising:
illuminating, by a light emitter, a target disposed within an apparatus and exposed to ambient air, wherein the target is representative of one or more components of a monitored system;
generating, by an optical detector, a measurement signal in response to receiving light reflected from the target; and
determining, by a processing device, a change in a physical property of the target based on the measurement signal generated by the optical detector.

13. (canceled)

14. The method of claim 12, further comprising:
illuminating, by a second light emitter, the target with a second frequency of light; and
generating, by a second optical detector, a second measurement signal in response to receiving light at the second frequency reflected from the target.

15. The method of claim 12, further comprising:
determining that the measurement signal generated by the optical detector satisfies a threshold; and
in response to determining that the measurement signal satisfies the threshold, generating an indication that the threshold is satisfied.

16. A system comprising:
a host system; and
an optical monitor communicatively coupled to the host system through a communication channel, the optical monitor comprising:
a target representative of one or more components of the monitored system, the target disposed within the optical monitor and exposed to ambient air, wherein exposure to the ambient air produces a change in an optical property of the target;
a light emitter configured to illuminate the target;
an optical detector configured to generate a signal based on light reflected from or transmitted through the target; and
a processing device configured to control operation of the optical monitor.

17. The system of claim 16, wherein the monitored system is a computer system and the optical property of the target changes due to corrosion of the target.

18. The system of claim 16, wherein the processing device of the optical monitor is further configured to:
receive a request from the host system, through the communication channel, to update a configuration parameter; and
update the configuration parameter in response to receiving the request.

19. The system of claim 16, wherein the change in the optical property of the target indicates the integrity of contacts and enclosures of the one or more components of the monitored system.

20. The system of claim 16, wherein the host system is configured to:
receive, through the communication channel, the signal generated by the optical detector from the processing device; and
determine a level of corrosion of the one or more components of the monitored system based on the signal generated by the optical detector,
wherein the monitored system is a server in a data center and the one or more components are structures in the server.
